(19) United States
(12) Patent Application Publication
(10) Pub. No.: US 2018/0148619 A1
(43) Pub. Date: May 31, 2018

(54) Stress-Optimized Adhesive Connection and Method for Producing a Stress-Optimized Adhesive Connection

(71) Applicants: Leibniz-Institut für Polymerforschung Dresden e.V., Dresden (DE); ATN Hölzel GmbH, Oppach (DE)

(72) Inventors: Andre Knapp, Dresden (DE); Martin Lucia, Dresden (DE); Thomas Brandler, Oppach (DE)

(21) Appl. No.: 15/565,147

(22) PCT Filed: Apr. 12, 2016
(86) PCT No.: PCT/DE2016/100172

§ 371 Date: Oct. 7, 2017

(30) Foreign Application Priority Data
Apr. 12, 2015 (DE) 10 2015 105 553.8

(51) Int. Cl. C09J 163/00; C09J 5/00; B32B 7/12; B32B 15/01; F16B 11/00

(52) U.S. Cl. CPC C09J 163/00; C09J 5/00; C09J 2463/00; B32B 15/016; F16B 11/006; B32B 7/12

(57) ABSTRACT

The task of the invention is to provide an improved solution for a bond for the surface gluing of components where the bond has an uneven distribution of stress in different areas of the adhesive surface. Corresponding to the stress, such as the distribution of tension, an adhesive should be adjustable in its properties to fit the tension within the adhesive surface, whereby advantageous effects between the respective adhesive adjustments should be used. Through this, a load-optimized bond is created for the overlapping connection of at least two components (5) under usage of a single adhesive (14), that has at least two components, whereby the components are mixed with each other and the adhesive (14) is applied on at least one of the components (5) at least in the area of the overlapping components (5) as an adhesive surface (4) and the components (5) overlap correspondingly and the adhesive (14) is curable, whereby corresponding to mechanical stress, the bond has corresponding component mixture ratios (1, 2, 3, n) in two, three or multiple areas of the adhesive area (4) of the adhesive (!4) in these areas of the adhesive area (4).

### CROSS REFERENCE TO RELATED APPLICATIONS

This application is the U.S. national stage of International Application No. PCT/DE2016/100172, filed on 2016 Apr. 12. The international application claims the priority of DE 102015105553.8 filed on 2015 Apr. 12; all applications are incorporated by reference herein in their entirety.

### BACKGROUND

The invention regards a load-optimized bond and procedure to establish a load-optimized bond while using a single adhesive through a variation of the component ratios adjusted to the arising tensions, in particular for flat components or parts with single, double or multi-shear overlapping.

For single shear, double shear or multi-shear overlapping bonds or concentric bonds with shear loads and/or peeling loads occur under the use of structural adhesives that are used for structural bonds that allow for a constructive design of highly-rigid construction bonds of a high strength, with high strength or stiffness. For a load of the adhesive layer, claims arise in the form of mechanical tension, which are improperly distributed and have their highest value (peak tension) respectively at the overlapping ends. These peak tensions lead to an uneven distribution of tension in the adhesive layer and therefore to a lower strength than would be the case with an even distribution of tension.

For flat bonds, the problem arises that the bonds on an edge of on multiple edges have greater loads than in other areas, such as in the middle of the adhesive surface.

The stress from the bond in different areas of the adhesive surface is influenced by all types of stress, adhesive film strengths and the strength of glued components.

Due to different stress in different areas of the bond, there is normally cracking on the edge of the edges with a subsequent growth of the cracking and therefore a destruction of the bond.

In particular with conventional bonds on overlapping components with an overlapping length that is a multiple of the overlapping length specified in DIN-1465, there are unfavorable tension distributions within the bond and the components to be joined.

Bonds are known in different designs.

From DE 102008024804 A1, an adhesive is known that is equipped with different adhesives of different properties distributed throughout the adhesive surface. Here it is imperative that the adhesive area at least has an initial partial area with an initial adhesive and at least a second partial area with a second adhesive and that the first adhesive and the second adhesive have different adhesive properties. With the suggested solution, a high temperature resistance, good durability and high initial bonding should be achieved. The described effect is only achieved with the aid of two different adhesives. A reduction of the peak tensions from bonds is not represented. Furthermore, the adhesives are applied through adhesive bands as a carrier, which causes certain adhesives to either not be used or only used with great expenses. An optimization regarding the strength for changing loads, however, is not possible.

Furthermore, the DE 101 26 743 A1 reveals a bond with two adhesives, whereby the adhesives on the one hand form a fixed bond and on the other hand should cause a seal. Different adhesives are used, which does not permit a continual solidity due to their composition. Furthermore, these adhesives harden differently. An application for optimization regarding strength for changing loads, however, is not possible. A disadvantageous effect of the different adhesives is not ruled out.

The DE 103 13 835 A1 also reveals a construction unit with a frame and a final piece, whereby the frame and final piece are made of materials with different thermal expansion coefficients and are glued to each other, whereby to secure a reliable bond there are mediums used in the form of limiters, which should provide a defined gap thickness for sufficient thickness of the adhesive layer.

### SUMMARY

The task of the invention is to provide an improved solution for a bond for the surface gluing of components where the bond has an uneven distribution of stress in different areas of the adhesive surface. Corresponding to the stress, such as the distribution of tension, an adhesive should be adjustable in its properties to fit the tension within the adhesive surface, whereby advantageous effects between the respective adhesive adjustments should be used. Through this, a load-optimized bond is created for the overlapping connection of at least two components (5) under usage of a single adhesive (14), that has at least two components, whereby the components are mixed with each other and the adhesive (14) is applied on at least one of the components (5) at least in the area of the overlapping components (5) as an adhesive surface (4) and the components (5) overlap correspondingly and the adhesive (14) is curable, whereby corresponding to mechanical stress, the bond has corresponding component mixture ratios (1, 2, 3, n) in two, three or multiple areas of the adhesive area (4) of the adhesive (!4) in these areas of the adhesive area (4). FIG. 5

### DETAILED DESCRIPTION

The task of the invention is to provide an improved solution for a bond for the surface gluing of components where the bond has an uneven distribution of stress in different areas of the adhesive surface. Corresponding to the stress, such as the distribution of tension, an adhesive should be adjustable in its properties to fit the tension within the adhesive surface, whereby advantageous effects between the respective adhesive adjustments should be used.

The invention shows that the task can be solved with the characteristics of the main claim.

With the load-optimized bond for the overlapping connection of at least two components under the use of an individual adhesive that includes at least two components, whereby the components are mixed with each other and the adhesive is applied to at least one of the components in at least the area of the overlapping components as an adhesive surface and the components are added correspondingly with overlapping and the adhesive is curable, the bond in two or more areas of the adhesive surface has the glue corresponding to mechanical stress in these areas of the adhesive surface corresponding to the component mixture ratios. Through the corresponding areas of the different component mixtures, a so-called graded bond is created whereby the area arrangement of the different component mixture ratios are to be understood here. (and less a gradual progress of the stress flow resulting from the different component mixture ratios)

The mechanical stress of the bond results from the stress of the components through pressure, tension and peeling, which should have a direct effect on the bond and should handle this stress.

A two-component product from the epoxy resin adhesive group is understood as an adhesive that is conventional and whose two significant components of epoxy resin and hardener can be mixed into an individual ratio. For the load-optimized bond, in different areas of the adhesive surface, the adhesive is used with respectively different component mixture ratios, which respectively have corresponding mechanical properties and therefore allow for a structural formation. For the load-optimized or gradual bond, the property change in the adhesive is direct or exploited, which is in the limits of the component mixture ratios that are required to reach the respective mechanical properties. The mechanical property to be changed is in regards to the stiffness, which can be achieved through the respective component mixture of the adhesive.

The solution for the load-optimized bond is distinguished in that an adhesive, however, with different stiffnesses set through the component mixture ratio, may be used corresponding to the tension distribution in different areas of the adhesive surface. In the stronger stressed areas, component mixtures with lower stiffness and in areas of lower stress adhesives with higher stiffness will be used. A structural bond is made in this manner.

They are used in areas of higher tension, such as at the edge, component mixtures with lower stiffness and component mixtures with higher stiffness in the area of lower tensions, such as in the middle of the adhesive surface, which corresponds to a local-functional structure of the bonds.

With flat bonding, the highest tension is found on the edge. There is basically no tension in the middle of large overlapping lengths. If the edge areas are bonded elastically and give, the result is that the central areas of the bond will also be stressed.

Adhesives from the epoxy resin adhesive group have the advantage that between the different component mixture ratios of the adhesive of the respectively adjacent areas of the adhesive surface, there are no disadvantageous effects in the event of contact or overlapping and therefore a superimposition, because both contain the same chemical components, which are only different regarding the respective quantity in the component mixture ratio. A mixing or diffusing of the components in the adjacent component mixture ratio is possible and permissible. In the overlapping areas or overlapping, there are component mixture ratios that act as a link between the component mixture ratios and combine their different stiffness and compensate for each other as an intermediate area.

Correspondingly, the resulting tension having effect on the bond is distributed evenly throughout the adhesive surface, which leads to an increase in the power of the bond. The adhesive area and therefore the overlapping areas of the components may be reduced, through which in addition to the reduction of the adhesive used, there is also a saving regarding the material strength of the components to be added or safety can be increased regarding the failure of the bond. Through the found solution, the stiffness and safety of the bond is increased with a constructively unchanged joint or a material-saving joint with consistent stiffness and safety is reached.

Load-optimized or graduated bonds have the potential to design structural bonds in the future with higher freedom in design. For example, now the resilience can be increased with greater overlapping lengths, the bond surfaces can be reduced with consistent stress or the adhesive layer thickness can be reduced with the same stress through larger overlapping lengths of the components, because tension peaks starting with a certain overlapping length of the components will lead to the failure of the component or the bond with conventional technology.

The subordinate claim affects a procedure for the production of a load-optimized or graduated bond of at least two components under usage of a single adhesive that includes at least two components and the adhesive is applied on at least one of the components in the area of the overlapping of the components as an adhesive surface and the components are added together overlapping and the adhesive hardens, whereby the components are mixed in respectively different ratios with each other and the adhesive is applied with the respectively different component mixture ratios in different areas of the adhesive surface of the components to be bonded corresponding to the stress of the bond and then added to the components to be bonded.

Suitable for the procedure to establish a load-optimized or graduated bond are all adhesives that allow for different properties through a variation of the component ratios without changing the chemical formulation. This includes in particular epoxy resin adhesives with a hardening responses as polyaddition responses of epoxy resins on the basis of Bisphenol A (also mixtures with Bisphenol F) with polyfunctional amines.

2K acrylate adhesives are not suitable as they cure under radical chain polymerization and normally have a fixed component ratio that cannot be changed.

Other advantageous designs of the invention are disclosed in the sub-claims.

The respective areas of the adhesive surface are designed symmetrical regarding the component mixture ratios. This allows for symmetrical tension paths with tension peaks reduced between the areas on the edges. Asymmetrical stiffness courses with maximum stiffness in the area between the edges and therefore minimal tension can be illustrated.

Correspondingly, it is also possible that the respective areas of the adhesive surface are designed as a course from one edge to another or as rotation-symmetrical regarding the component mixture ratios, provided that the deformation or movement of the components would lead to an expected tension course in the bond or the respective geometry of the components to be joined.

Due to the fact that the respective areas of the component mixture ratios are arranged next to each other in the direction of the stress, it is achieved that the tension course resulting from the different component mixture ratios with the different stiffnesses aligns in particular in the direction of stress and therefore does not result in an undefined tension course and therefore unreliable bond.

The different areas of the adhesive areas overlap and/or border each other and form the transition areas of the component mixture ratio. The result is that the transitions between the areas have a beneficial effect on a more continual stress flow. If the areas only border each other, the transition in the stress flow is more volatile corresponding to the areas.

The bond has an advantageous design, whereby the transition areas of the component mixture ratios have a continual course of mechanical properties through the mixture causing the stress flow in the bond to be benefited and a partial overload of the adhesive area is avoided and therefore there is no destruction or tearing.

By having the respective areas of the component mixture ratios arranged next to each other in the stress direction, independent of the component and the arrangement of the respective overlapping of the components to be bonded, a bond is created where the stress flow, which results through the different component mixture ratios, is oriented in the direction of stress and therefore results in a reliable bond. If different stresses or different stress directions occur, different alignments of the adhesive surfaces would be required with different arrangements of the areas of the component mixture ratios corresponding to the stress direction. Nevertheless, here it must be considered that only the adhesive surfaces arranged in the stress direction allow for a reliable bond, while differently arranged or differently orientated adhesive surfaces for correspondingly different stress directions provide no support for the reliable bonding of the initially named stress direction.

In accordance with the further formation of the invented procedure, the adhesives of different component mixture ratios are applied individually after each other and/or together at the same time to the different areas of the adhesive surface. The adhesive with the respective component mixture ratio is applied for the respective areas through spray nozzles on a component or both components in the area of the adhesive surface sectors for which the component mixture ratio was previously determined. Depending on the scope of the areas, multiple stripes of the adhesive are applied after each other. For example, adhesive with a component mixture ratio with a higher stiffness is applied in the middle and adhesive with a component mixture ratio with less stiffness is applied in the edge area. Different spray nozzles with respective storage tanks are used for this.

In accordance with the formation of the invention, the different component mixtures are applied together at the same time, for example, through multi-channel flat nozzles. The application of adhesive individually in a subsequent manner leads to the same result as the application of the adhesive at the same time. However, the mutual simultaneous, therefore, parallel application of the adhesive has the benefit that the adhesive cannot already flow off in areas on which the corresponding component mixture should be applied afterwards. Simultaneously, there is a saving in time. Thus, this solution is predestined for fully-automatic bonding.

Moreover, the different areas of the adhesive surface are attached overlapping and/or arranged next to each other on the side. A transition area of the component mixture ratios is formed here. This results in advantages regarding a continual stress flow within the bonds. Volatile changes in the stress flow are avoided. Reliability and quality of the bonds are improved.

The adhesive is applied with the respectively different component mixture ratios for a direct mechanical property and with directly defined width on the respective areas of the adhesive surface, which increases the freedom of design when creating and dimensioning the respective overlapping of the components for bonding. This allows, for example, the reduction of the adhesive surface with simultaneous stress or reduction of the adhesive layer width with even stress through greater overlapping lengths of the components.

Corresponding to the design of the procedure for the production of a load-optimized bond, limiters are positioned on the overlapping ends of the load-optimized adhesive layer. The limiters between the components on the overlapping ends of the load-optimized adhesive layer serve to establish a defined and reproducible adhesive layer thickness as well as for the spatial limitation or fixation of the load-optimized adhesive layer. This increases the solidity and security of the bond. Furthermore, a reproducible and secure establishment of the bond is supported. Simultaneously, the quality assurance can therefore be realized. The limiters can also be designed so that the spatial limitation and local or surface fixation occurring through their arrangement helps to prevent the adhesive from flowing outside of the adhesive surface.

Advantageously, when adding the components and/or when applying the adhesive with the respective component mixture, a mixture results of the transition areas of the component mixture ratios. When joining components and already during the application of the adhesive, a continual flow of the mechanical properties is achieved through a mixture of the transition areas of the component mixture ratios, which in turn results in a continual stress flow in the adhesive surface. Through the continual stress flow, the stiffness jumps of the component mixture ratios within the adhesive surface are at least reduced, which prevents a partial overloading of the adhesive surface and works against destruction or tearing.

### BRIEF DESCRIPTION OF THE DRAWINGS

Advantageous execution examples of the invention are explained in detail based on drawings.

The following is shown:

FIG. 1 a perspective view of the applied adhesive mixtures,

FIG. 2 a bond with concentrically applied component mixtures on the adhesive surface,

FIG. 3 two bonded components 5 with an adhesive layer and limiters and

FIG. 5 a bond with affiliated flow of the stiffness as a diagram.

### DETAILED DESCRIPTION OF THE PREFERRED EMBODIMENTS

The execution examples are regarding the exemplary component mixtures 1, 2, 3, n made of epoxy resin and correspondingly effective hardener. The selected number of three different component mixtures 1, 2, 3 is not limited to this. In addition to the three illustrated component mixtures, the invention includes other component mixtures n with other component mixture ratios n for a bond if, for example, a finger classification of the stiffness of the respective component mixtures 1, 2, 3, n is required depending on the application case and requirement for the bond assuming the expected stress flow in the bond.

The requirement for the component mixture 1, 2, 3, n include the adjustability of the degree of interlinking through the component mixture ratio 1, 2, 3, n and therefore through a large area of adjustable stiffnesses or as the case may be the stiffness of the adhesive 14.

For the production of an overlapping load-optimized bond, a 2-component epoxy resin adhesive is used that reacts with primary and secondary amino groups through an amino hardener. Through different response properties of the primary and secondary amino groups, different cross-linking can be realized in the cured adhesive 14 of the respective component mixture ratios 1, 2, 3, n through excess or low dosage of the hardener, which in turn influences the mechanical properties. The components 5 consist, for example, of aluminum, which are bonded with this adhesive 14 with the respective component mixture ratios 1, 2, 3, n. Corresponding to the adhesive properties with different component mixture ratios 1, 2, 3, n, these are applied directly on the adhesive surface 4.

After application of adhesive 14 with its respective component mixture ratios 1, 2, 3, n on the components on the adhesive surface 4, up until usage of the linking or hardening of the adhesive, the components 5 are added to the adhesive surface corresponding to the respective specification of the adhesive 14 with its components. If the adhesive 14 is hardened, the further processing of the components 5 put together through gluing may be performed.

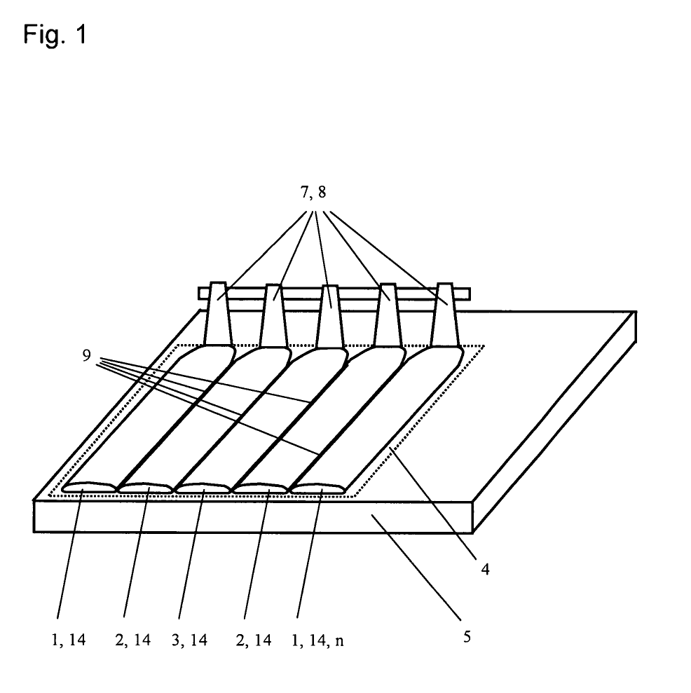

A bond is shown in a perspective illustration in FIG. 1. Different component mixtures 1, 2, 3, n are applied in stripes on adhesive surface 4. The stripes of the component mixtures 1, 2, 3, n each have different component mixture ratios 1, 2, 3, n of epoxy resin to hardener. The component mixture 1 has a lower stiffness than the component mixture 2. The component mixture 2 in turn has a lower stiffness than the component mixture 3 with a medium stiffness, which has the highest stiffness with a high stiffness. The component mixtures 1, 2, 3, n are applied on the component 5 in stripes. The application may be performed at the same time or individually in sequential order. The mutual simultaneous application of component mixtures 1, 2, 3, n is illustrated here. The component mixtures 1, 2, 3, n are applied parallel to each other at the same time through multiple nozzles 7. The different component mixtures 1, 2, 3, n leave the individual nozzles 8 at the same time or offset in time. In this way, it is prevented that adhesive 14 flows into areas that are equipped with serial, therefore individual, subsequent application with adhesive. This allows for adhesive with a lower viscosity to be used.

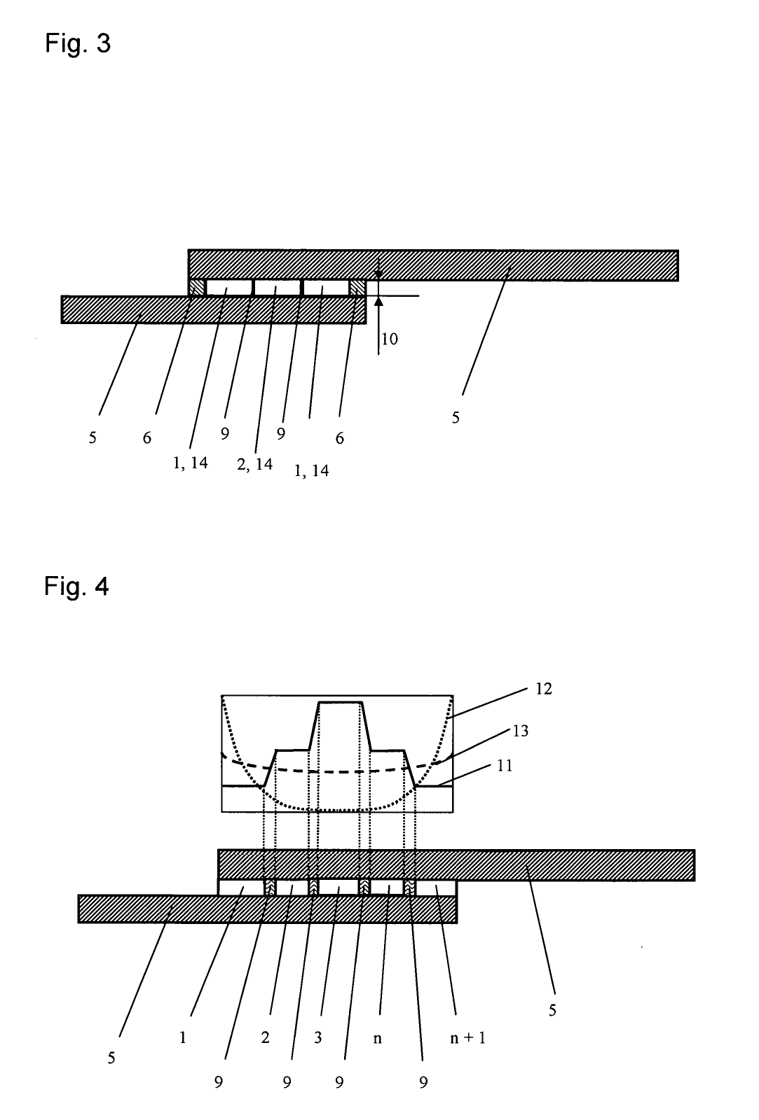

After application to the component mixtures 1, 2, 3, n are added to the components 5, as illustrated in FIG. 3. The component mixtures 1, 2, 3, n can be applied to one or both components 5. Normally the application on one component 5 is sufficient.

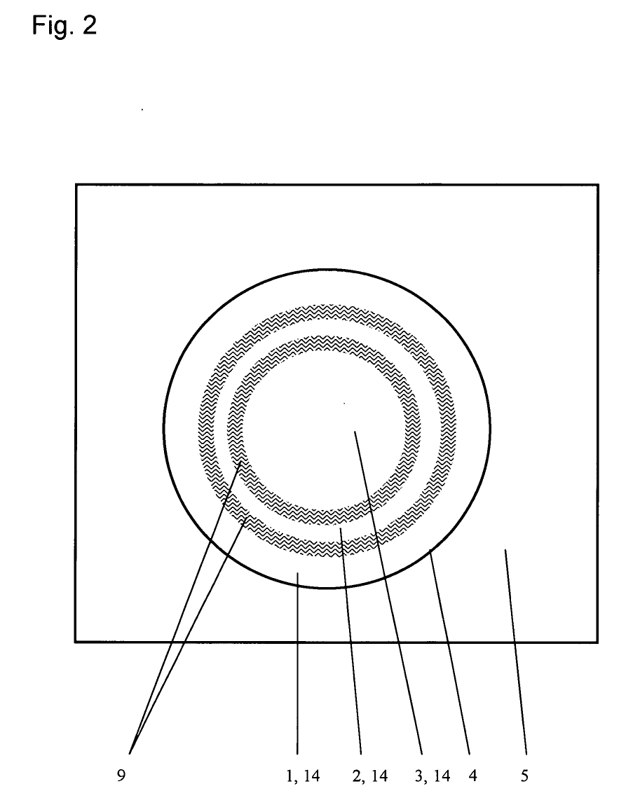

In the top view, FIG. 2 shows a bond with component mixtures 1, 2, 3, n applied concentrically on the adhesive surface. Higher tensions occur on the edge depending on the stress. Correspondingly, the component mixture with low stiffness 1 is used here. The component mixture with high stiffness 3 is used in the middle. A component mixture with medium stiffness 2 is used between these two areas. In the areas in which the component mixtures 1, 2, 3, n are adjacent, during application of adhesive 14 and later when joining the components 5, a retrospective mixture will be made on the adhesive surface 4 so that a transition area 9 is formed from component mixture 1 to component mixture 2 and from component mixture 2 to component mixture 3. In this transition area 2, the properties also continue to flow from component mixture 1 to component mixture 2 and from component mixture 2 to component mixture 3, which ensures a continual stress flow.

The designs for the concentric bond apply also to non-concentric bonds such as a lengthwise overlapping gluing of two stretched components 5, because the same principles apply here assuming the power effects to be assumed from the expected stress flows. This leads to the areas of the adhesive surface 4 with different component mixture ratios 1, 2, 3 of the adhesive 14 run corresponding to the expected stress flows coming from an area of lower tension with high stiffness of the component mixture 3 symmetrically respective to areas of higher tension with respectively low or lower stiffness of the component mixture 1, 2.

Depending on the component, however, it may also mean that there is not a single, asymmetrical course for the load-optimized bond that runs from an area of low tension with high stiffness of component mixture 3 to the area of higher tension with respectively low or lower stiffness of the component mixture 1, 2.

This permits the load-optimized bond and the procedure for production that forms a variety of individual areas of different tension depending on the material and requirements and applies the component mixture 1, 2, 3 adjacent for a resulting tension process with different stiffness.

FIG. 3 shows two single-shear overlapping and glued components 5 with an adhesive layer and limiters 6. Two different component mixtures 1, 2 are illustrated. The stiffness of the respective adhesive layer is determined by the affiliated shear modulus. To realize defined properties of the bond, it is therefore important to realize a certain thickness 10 of the adhesive layer. Limiters 6 are arranged for this here in the edge area of the bonding. The limiters 6 serve here simultaneously for ensuring the component mixture 1 in the edge area does not flow off. Component mixtures 1, 2 can be used with lower viscosity through this. The limiters 6 can be designed so that they are easy to remove by selecting a material that has poor adhesive properties, for example PTFE or remain protection of the adhesive layer in this. After a possible removal, if necessary, the space may be filled with a corresponding component mixture 1, 2, 3, n or a sealant.

FIG. 4 shows a bond with three different component mixtures 1, 2, 3, n, n+1 for the connection of the components 5 with an affiliated diagram of the course of the stiffness of adhesive 11 an the stress flow in the adhesive layer without adjustment of the stiffness 12 and the stress flow in the adhesive layer with adjustment of the stiffness 13. In the diagram, the principle course of the stiffness of the adhesive 11 is illustrated as the actual course with its classifications between the respective component mixtures 1, 2, 3, n, n+1 of the adhesive 14 through the width of the bond. Between the individual component mixtures 1, 2, 3, n, n+t, transition areas 9 are formed that are realized through a mixture of the component mixture 1, 2, 3, n, n+1 in the areas in which they order each other. In the transition area 9 for the adhesive application and when joining, the arrangement of the components 5 to bond a mixture of the respective component mixture ratios 1, 2, 3, n. The mixture may be actively made as well. Through the resulting classification of the stiffness of the component mixtures 1, 2, 3, n, n+1, a comparison of the tensions in the bond occurs. The principle stress flow is shown respectively continually for an adhesive layer without variation of the stiffness 12 with an adhesive 14. If there is low stiffness in the area of high tension in the adhesive layer 12 of the adhesive 14, the tension on the overlapping ends decreases and adhesive areas in the middle have greater stress, which reduces the stress of the adhesive layer and the component 5. The component mixtures identified as n and n+1 correspond to the stiffness of the component mixtures 1 and 2 in this example. They may also have different stiffnesses depending on the respective application.

An unillustrated example for a design of the adhesive surface regarding the component mixture ratios as a course from one edge to another can be illustrated in that the component mixture ratio has a low stiffness on one edge and correspondingly next to this there may be, for example, five different component mixture ratios up to a component mixture ratio with the corresponding highest stiffness in the direction of stress.

Correspondingly, an unillustrated example for a design of the adhesive surface regarding the component mixture ratios can be shown as an asymmetrical course, whereby in the area of the component overlapping on the adhesive surface an area with a component mixture ratio is arranged not in the middle with a higher stiffness and respectively next to this up to the edge of the adhesive surface there are other areas with component mixture ratios that have a lower stiffness when running out to the edge, whereby on one side a partial area is arranged more than on the other side with a component mixture ratio.

Through the procedure and type of bond, components 5 made of 5 different materials can be optimized with different material properties and with different geometries and therefore conditional other mechanical properties.

For example, the 2K epoxy adhesive UHU PLUS Endfest is used, whereby joining parts made of aluminum are joined that were previously treated with surface beam treatment Korund EKL90 according to DIN1465. In addition to this, the surfaces to be bonded in this concrete example were pretreated to promote bonding.

Thus, a load-optimized bond could be realized that have an up to 50% higher breaking force than standard bonds with the same geometry and pretreatment with large overlapping lengths. The breaking force, therefore the stiffness, could be increased with single-sheared overlapping bonds with a 50 mm overlapping length of 10.4 kN (8.3 MPa) to 15.5 kN (12.4 MPa) through an optimal graduation.

### LIST OF REFERENCE NUMERALS

1—first component mixture ratio, component mixture with low stiffness
2—second component mixture ratio, component mixture with medium stiffness
3—third component mixture ratio, component mixture with high stiffness
n—different component mixture ratio, different component mixture
4—Adhesive surface
5—Component
6—Limiter
7—Multiple nozzles
8—Single nozzle
9—Transition area
10—Thickness
11—Process of stiffness of the adhesive
12—Stress curve in the adhesive layer without adjusted stiffness
13—Stress curve in the adhesive layer with adjusted stiffness
14—Adhesive

1. Load-optimized bond for the overlapping connection of at least two components (5) under usage of a single adhesive (14), that has at least two components, whereby the components are mixed with each other and the adhesive (14) is applied on at least one of the components (5) at least in the area of the overlapping components (5) as an adhesive surface (4) and the components (5) overlap correspondingly and the adhesive (14) is curable,
characterized in
that the adhesive is an epoxy resin adhesive that has different stiffnesses set through the component mixture ratio corresponding to the tension distribution in different areas of the adhesive surface, whereby correspondingly a mechanical stress of the bond in two, three or multiple areas of the adhesive surface (4) of the adhesive (14) in these areas of the adhesive surface (4) has corresponding component mixture ratios (1, 2, 3, n).

2. Bond according to claim 1,
characterized in
that the respective areas of the adhesive area (4) are symmetrical regarding the component mixture ratios or are designed as a process or rotation-symmetrical.

3. Bond according to claim 1,
characterized in
that the respective areas of the component mixture ratio (1, 2, 3, n) being arranged next to each other in the direction of stress.

4. Bond according to claim 1,
characterized in
that the different areas of the adhesive area (4) overlap and/or adjacent to each other and form transition areas (9) of the component mixture ratios (1, 2, 3, n).

5. Bond according to claim 1,
characterized in
that the transition area (9) of the component mixture ratios (1, 2, 3, n) has a continual process of the mechanical properties through mixture.

6. Method for the production of a load-optimized bond for the overlapping connection of at least two components (5) under usage of a single adhesive (14), that has at least two components and the adhesive (14) is applied on at least one of the components (5) at least in the area of the overlapping of the components (5) as adhesive surface (4) and the components (5) are joined overlapping and the adhesive (14) cured,
characterized in
that the components are mixed with each other in respectively different ratios and the adhesive (14) with the respectively different component mixture ratios (1, 2, 3, n) are added to different areas of the adhesive surface (4) of the components to be glued together (5) corresponding to the stress of the bond and are added to the glued components (5) after each other.

7. Method according to claim 6,
characterized in
that the respective areas of the component mixture ratio (1, 2, 3, n) being arranged next to each other in the direction of stress.

8. Method according to claim 6,
characterized in
that the adhesive (14) is attached with the respectively different component mixture ratios (1, 2, 3, n) on the corresponding areas of the adhesive surface (4) individually after each other and/or together at the same time, whereby the different areas of the adhesive surface (4) are attached overlapping and/or adjacent to each other and a transition area (9) of the component mixture ratios (1, 2, 3, n) is formed.

9. Method according to claim 6,
characterized in
that the adhesive (14) is attached with the respectively component mixture ratios (1, 2, 3, n) for a mechanical property and with a defined width on the respective areas of the adhesive surface (4).

10. Method according to claim 6,
characterized in
that limiters (6) are positioned on the overlapping ends of the load-optimized adhesive layer.

11. Method to produce a bond according to claim 6,
characterized in
that when adding the components (5) and/or when applying the adhesive (14) with the respective component mixture ratio (1, 2, 3, n), a mixture results of the transition areas (9) of the component mixture ratios (1, 2, 3, n).
